(19) United States
(12) Patent Application Publication
(10) Pub. No.: US 2015/0123008 A1
(43) Pub. Date: May 7, 2015

(54) ION GENERATOR

(71) Applicant: Koganei Corporation, Tokyo (JP)

(72) Inventor: Yoshinari Fukada, Tokyo (JP)

(21) Appl. No.: 14/381,460

(22) PCT Filed: Nov. 8, 2012
(86) PCT No.: PCT/JP2012/079013

§ 371 Date: Aug. 27, 2014

(30) Foreign Application Priority Data
Mar. 8, 2012 (JP) 2012-051793

(51) Int. Cl. H01T 23/00; H01J 27/02

(52) U.S. Cl. CPC H01T 23/00; H01J 27/022
USPC 250/423 R

(57) ABSTRACT

In an ion generator, a flexible discharge electrode 44 composed of one wire is provided to a base 43, and a swinging motion or a turning motion of a free end 44b of the discharge electrode 44 about a fixed end 44a of the discharge electrode 44 is performed by repulsive force of a corona discharge generated by supplying a high voltage to the fixed end 44a. Therefore, in comparison with a discharge electrode composed of a bundle of thin wires, it is possible to significantly reduce dust emission from the free end 44b of the discharge electrode 44, and to further improve the ion generator 30 in maintenance interval. Since the discharge electrode 44 is compose of one wire, it is possible to reduce the discharge electrode 44 in size, easily observe the state of the discharge electrode 44, and simplify its maintenance. Since the discharge electrode 44 performs the swinging motion or the turning motion, it is possible to transport the generated air ions EI to a wide area of a packaging film 10, and to enhance ionizing efficiency.

### TECHNICAL FIELD

The present invention relates to an ion generator for generating air ions which are used for neutralizing and eliminating static electricity from an electrically-charged object such as for example a jig for assembling electronic parts, and a packaging film made of plastic material.

### BACKGROUND ART

When a packaging film made of plastic material, a jig for assembling electronic parts, or the like is electrically charged, since the electronic parts may be broken by static electricity, or dusts and the like may be attached to those objects by static electricity, assembling workability and packaging workability tend to be reduced. Therefore, in order to prevent their workability from being reduced by static electricity or to improve yield rate, an ion generator also referred to as an ionizer or an ion generator is used. As examples of this ion generator, a blow type configured to supply air ions, by tube or pipe, to a specific part to electrically neutralize the specific part, and a fan type configured to blow a specific part with air ions from an outlet of the ion generator to electrically neutralize the specific part have been known.

The ion generator is an apparatus for generating positive or negative air ions to neutralize and eliminate static electricity by supplying the air ions to an electrically-charged section. The ion generator is provided with an electrode such as a discharge needle to which a high voltage is applied, and an alternating voltage or a pulse-like direct voltage of several kilovolts (for example, 7 kilovolts) or higher is applied to this electrode. When the high voltage is applied to the electrode, a corona discharge is generated from the electrode, and air around the electrode is ionized by this corona discharge.

For example, techniques disclosed in Patent Document 1 are known an ion generator such as this. In the techniques disclosed in Patent Document 1, a bundle electrode composed of thin wires bundled like a brush is used as an electrode. A high voltage is applied to the bundle electrode from a high voltage supply, and each thin wire of the bundle electrode is electrified by application of the high voltage. Then, because of electrification of the thin wires, the thin wires repel one another, the distal end portion of the bundle electrode is expanded radially, and the corona discharge is generated in this state. In this manner, in the techniques described in Patent Document 1, air ions are generated in a large area to improve ionizing efficiency while downsizing this apparatus by using the bundle electrode.

### PRIOR ART DOCUMENTS

### Patent Documents

Patent Document 1: Japanese Patent Application Laid-Open Publication No. 2008-034220

### DISCLOSURE OF THE INVENTION

### Problems to be Solved by the Invention

However, according to the techniques disclosed in the above Patent Document 1, for example, since a bundle electrode is composed of 100 ultrafine thin wires made of stainless steel and bundled like a brush, this apparatus encounters such a problem that dust emission from the thin wires is caused along with corona discharge. More specifically, the amount of dust emission to the outside is increased with increase in the number of the bundled thin wires. And dusts attached to the thin wires reduces the generation amount of air ions (ionizing efficiency is lowered).

Furthermore, in the bundled thin wires of this electrode, thin wires as its central part largely differ in bending deformation from thin wires as its outer peripheral part. More specifically, when the diameter of the distal end portion of the bundle electrode is radially expanded at the time of corona discharge, the thin wires of the central part are approximately straight and do not undergo bending deformation almost at all, while the thin wires as the outer peripheral part largely undergo bending deformation (for example, bent at a right angle). Therefore, since the thin wires as the outer peripheral part are easily broken (worn), and it is necessary to frequently observe the state of the bundle electrode, thereby causing complicated maintenance.

It is an object of the present invention to provide an ion generator simplified in maintenance and improved in ionizing efficiency.

### Means for Solving the Problems

An ion generator according to the present invention comprises a flexible discharge electrode which is composed of one wire, and which has a fixed end and a free end; wherein repulsive force of a corona discharge generated by supplying a high voltage to the fixed end causes the free end side to perform a turning motion or a swinging motion around the fixed end.

The ion generator according to the present invention comprises a turning-motion control member for controlling a turning motion of the discharge electrode. In the ion generator according to the present invention, the discharge electrode is disposed in an air supply channel for guiding air toward an air outlet, and the free end performs the swinging motion. In the ion generator according to the present invention, the free end of the discharge electrode performs the swinging motion in a crossing direction with respect to air flow toward the air outlet. In the ion generator according to the present invention, the discharge electrode is disposed so as to extend along the air outlet. In the ion generator according to the present invention, the discharge electrode is disposed so as to extend toward the air outlet. In the ion generator according to the present invention, the discharge electrode is set to 100 micrometers or less in cross section dimension. In the ion generator according to the present invention, the discharge electrode is formed of titanium alloy.

### Effects of the Invention

Since the ion generator according to the present invention comprises a flexible discharge electrode composed of one wire, and a turning motion or a swinging motion of the free end of the discharge electrode around the fixed end is performed by repulsive force of a corona discharge generated by supplying a high voltage to the fixed end, in comparison with a bundle electrode composed of thin wires, dust emission from the free end of the discharge electrode can be significantly reduced, and this apparatus can be further enhanced in maintenance interval. Since the discharge electrode is composed of one wire, the downsized ion generator can be realized, furthermore, the state of the discharge electrode can be easily observed, and its maintenance can be simplified. Since the discharge electrode performs a turning motion or a swinging motion, the generated air ions can be transported to a wide area of an object to be electrically neutralized, and ionizing efficiency can be improved.

Since the ion generator according to the present invention further comprises a turning-motion control member for controlling a turning motion of the discharge electrode, the size of a delivery area to which the generated air ions are carried can be arbitrarily controlled in accordance with, for example, the shape of the object to be electrically neutralized.

In the ion generator according to the present invention, since the discharge electrode performs the swinging motion in a crossing direction with respect to air flow in the air supply channel, air ions can be broadly diffused into the air flow. Therefore, air ions to be discharged from the air outlet are homogeneously distributed to uniform its distribution density.

In the ion generator according to the present invention, since the discharge electrode is set to 100 micrometers or less in cross section dimension, the discharge electrode has sufficient flexibility, and the generated air ions can be transported to a wide area.

In the ion generator according to the present invention, since the discharge electrode is formed of titanium alloy, in comparison with for example tungsten alloy, dust emission can be reduced while ensuring high strength, and this apparatus can be further enhanced in maintenance interval.

### BRIEF DESCRIPTION OF THE DRAWINGS

FIG. 1 is an explanatory diagram explaining one application case of an ion generator according to the present invention;

FIG. 2 is an explanatory diagram explaining the structure of the ion generator according to the first embodiment;

FIG. 3 is an A-arrow diagram explaining the size of a delivery area to which air ions are carried, in the ion generator shown in FIG. 2;

FIG. 4 is an explanatory diagram corresponding to that of FIG. 2, and showing a comparison example of the ion generator (fixed discharge electrode specification);

FIG. 5 is a B-arrow diagram explaining the size of a delivery area to which air ions are carried, in the ion generator (comparison example) shown in FIG. 4;

FIG. 6 is an explanatory diagram explaining the structure of the ion generator according to the second embodiment;

FIGS. 7A and 7B are explanatory diagrams explaining a first setup state (delivery width: small) of the ion generator shown in FIG. 6;

FIGS. 8A and 8B are explanatory diagrams explaining a second setup state (delivery width: middle) of the ion generator shown in FIG. 6;

FIGS. 9A and 9B are explanatory diagrams explaining a third setup state (delivery width: large) of the ion generator shown in FIG. 6;

FIG. 10 is an explanatory diagram explaining a main section of the ion generator according to the third embodiment;

FIGS. 11A, 11B, and 11C are explanatory diagrams respectively explaining the structures of the ion generators according to fourth to sixth embodiments;

FIG. 12 is a front view showing an ion generator according to the seventh embodiment;

FIG. 13 is a plan view of FIG. 12;

FIG. 14 is a cross sectional view taken along a line E-E in FIG. 13;

FIG. 15 is a plan view showing an ion generator according to the eighth embodiment;

FIG. 16 is a right side view of FIG. 15;

FIG. 17 is a cross sectional view taken along a line F-F in FIG. 15;

FIG. 18 is a front view showing an ion generator according to the ninth embodiment;

FIG. 19 is a cross sectional view of FIG. 18;

FIG. 20 is a front view showing an ion generator according to the tenth embodiment;

FIG. 21 is a cross sectional view showing an ion generator according to the eleventh embodiment;

FIG. 22A is a schematic view showing an air ion generating state by a swinging type discharge electrode; and

FIG. 22B is a schematic view showing an air ion generating state by a fixed type discharge electrode.

### BEST MODE FOR CARRYING OUT THE INVENTION

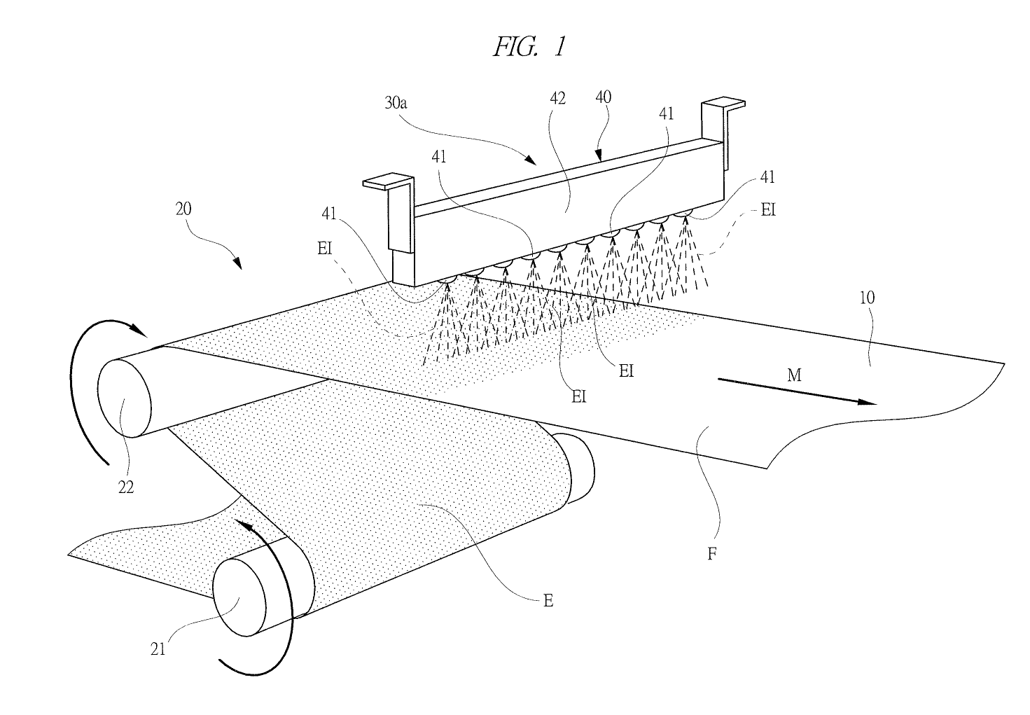

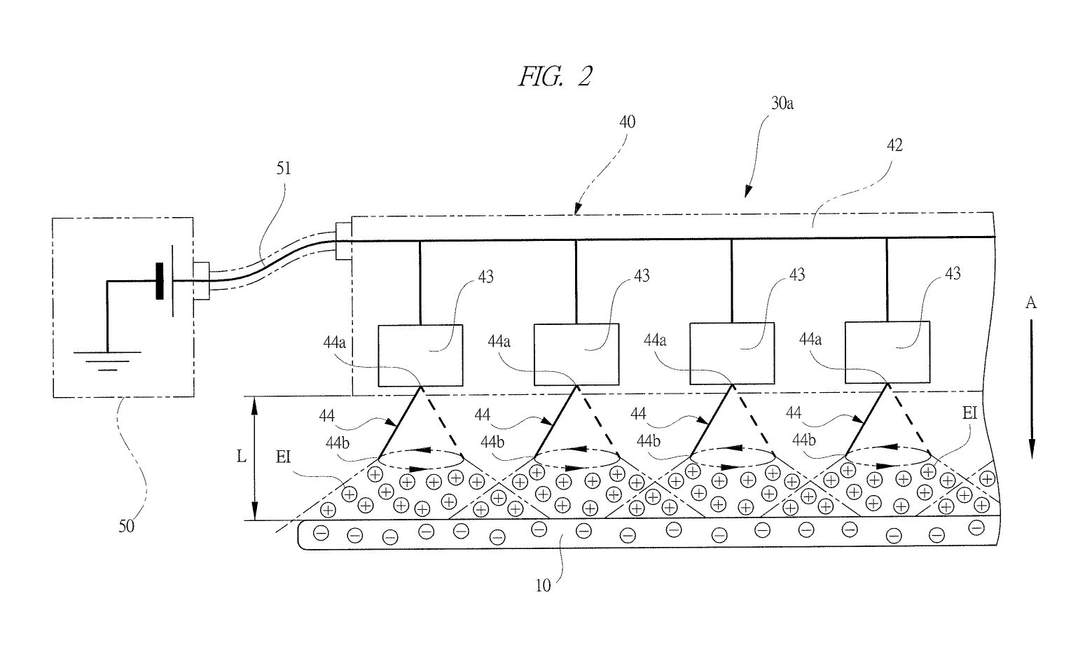

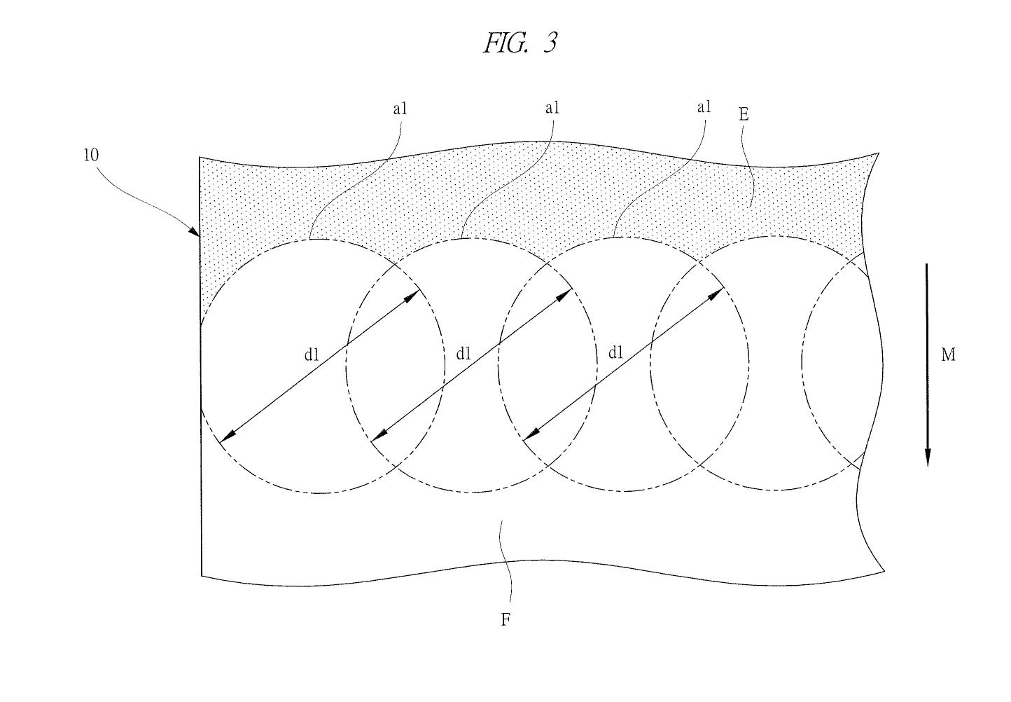

Hereinafter, the first embodiment of the present invention will be explained in detail with reference to the drawings. FIG. 1 is an explanatory diagram explaining one application case of an ion generator according to the present invention, FIG. 2 is an explanatory diagram explaining the structure of the ion generator according to the first embodiment, and FIG. 3 is an A-arrow diagram explaining the size of a delivery area to which air ions are carried, in the ion generator shown in FIG. 2.

FIG. 1 shows a case in which an ion generator 30a is applied to a film supplying apparatus 20 which supplies a packaging film (object) 10. The ion generator 30a is used for electrically-neutralizing and eliminating static electricity from the packaging film 10 as an object to be electrically neutralized.

As shown in FIGS. 1 and 2, the ion generator 30a is provided with: a device main body 40 which generates air ions “EI”; a power-supply unit 50 which supplies a high voltage of about 5 kilovolts to the device main body 40; and a power-supply cable 51 which has a first-end side electrically connected to the power-supply unit 50, and a second-end side electrically connected to the device main body 40. Additionally, although the power-supply unit 50 shown in FIG. 2 is configured to supply a positive high voltage, it may supply a negative high voltage. Furthermore, both a positive high-voltage power-supply unit and a negative high-voltage power-supply unit may be prepared so as to supply these high voltages to respective device main bodies 40.

The device main body 40 is a so-called bar type ionizer, and is mounted to a predetermined portion of a supporting frame (not shown) forming the film supplying apparatus 20, and located so as to face the moving packaging film 10. The device main body 40 is configured to generate a corona discharge by application of a high voltage from the power-supply unit 50, so that surrounding air is ionized by the corona discharge, and to generate positive or negative air ions “EI”. Then, the generated air ions “EI” are blown toward the packaging film 10.

The thin sheet-shaped packaging film 10 is made of plastic material, and its distal-end side is fed in the direction of an arrow “M” by rotary drive of a pair of roller members 21 and 22 in the directions of arrows in the drawing. In this process, the packaging film 10 is electrostatically charged when the film is brought into contact with and then separated from the roller members 21 and 22. And, in order to immediately electrically neutralize and eliminate the static electricity, and to prevent dusts and the like from being attached to this film, the packaging film 10 is passed near the device main body 40 just after passing through the roller members 21 and 22.

The device main body 40 has a plurality of discharge nozzles 41, and the discharge nozzles 41 are arranged at regular intervals along the longitudinal direction of the device main body 40. The air ions “EI” are blown from each of the discharge nozzles 41 toward the packaging film 10. The air ions “EI” blown from the discharge nozzles 41 reach the packaging film 10, and electrically neutralize and eliminate the static electricity of an electrically-charged portion “E”, which has static electricity, in the packaging film 10 (shaded area in the drawing). In this manner, the static electricity can be eliminated from the packaging film 10 when passing near the device main body 40. The character “F” in FIG. 1 shows an electrically neutralized portion.

In this case, as shown in FIG. 1, the device main body 40 is disposed so that its longitudinal direction becomes parallel to the width direction of the packaging film 10 (i.e., direction orthogonal to the direction of the arrow “M”). However, for example, if the packaging film 10 is small in width, the device main body 40 may be disposed so that its longitudinal direction becomes parallel to the feeding direction of the packaging film 10 (i.e., direction of the arrow “M”). In this case, since the air ions “EI” can be transported to the electrically-charged portion “E” of the packaging film 10 for a long period of time, electrical-neutralization time can be increased correspondingly, so that electrical neutralization is efficiently carried out.

Hereinafter, explanation will be given on the assumption that the packaging film 10 is electrically charged with negative static electricity (minus), and positive (or plus) air ions “EI” which are used to electrically neutralize the static electricity, are blown from the discharge nozzles 41.

The device main body 40 forming the ion generator 30a has a casing 42 formed into an approximately rectangular parallelepiped shape. In this casing 42, a plurality of bases 43 is provided at approximately regular intervals along its longitudinal direction. Each of the bases 43 is formed into an approximately cylindrical shape by using resin material such as for example plastic, and second-end-side terminals (not shown) branched from the power-supply cable 51 are inserted into the upper ends of the bases 43 in the drawing.

Fixed ends (base ends) 44a of the discharge electrodes 44 which form the discharge nozzles 41 are respectively inserted into lower and center portions of the bases 43 in the drawing. The discharge electrodes 44 are provided so as to correspond to the respective bases 43, and the fixed ends 44a of the discharge electrodes 44 are respectively electrically connected to the other end terminals of the power-supply cable 51 in the bases 43. The discharge electrodes 44 are respectively electrically connected to the second-end-side terminals of the power-supply cable 51 in the respective bases 43 by attaching the discharge nozzles 41 to the casing 42.

Each of the discharge electrodes 44 is made of titanium alloy, and formed into a thread-like shape having a circular cross section, and its diameter is set to 100 micrometers (0.1 millimeters) or less, for example, to 70 micrometers (0.07 millimeters). Therefore, each of the discharge electrodes 44 made of titanium alloy having relatively high hardness has flexibility and is elastically deformable, and a distal-end side of each of the discharge electrodes 44 constitutes a free end 44b which can move freely in the front/rear/left/right directions. Therefore, repulsive force from the corona discharge generated by application of the high voltage causes the free end 44b of the discharge electrode 44 to perform a turning motion around the fixed end 44a so as to form an approximately conical shape in a predetermined angle range as shown by two-dot-line arrow in the drawing.

Here, the size of the turning motion of the free end 44b, in other words, the size of the circle formed by the free end 44b is determined by the rigidity of the discharge electrode 44 and the magnitude of the voltage applied to the discharge electrode 44. For example, if the discharge electrode 44 is reduced in rigidity, the discharge electrode 44 can be easily elastically deformed, and as a result, the turning motion can be increased in size. If the voltage applied to the discharge electrode 44 is increased, the size of the repulsive force from the corona discharge can be increased, and the size of the turning motion can be increased as a result.

However, when the discharge electrode 44 is composed of a further-thinned wire, or the applied voltage is further increased, the amount of the elastic deformation of the discharge electrode 44 at the time of corona discharge becomes too large, and the discharge electrode 44 may be broken. Therefore, the minimum diameter of the discharge electrode 44 and the magnitude of the voltage applied to the discharge electrode 44 are determined in consideration of the rigidity of the material (for example, titanium, tungsten, stainless steel) which forms the discharge electrode 44. In the present embodiment, titanium alloy having sufficient flexibility and rigidity and capable of suppressing the amount of dust emission to a low level is used as an optimum material.

Furthermore, since each of the discharge electrodes 44 is provided to the corresponding base 43, and its turning motion is prevented from being disturbed by contact with other discharge electrodes 44 and the like, each of the discharge electrodes 44 is elastically deformed in the same angle range in the front/rear/left/right directions to perform out turning motions. As a result, as shown in FIG. 3, the air ions EI can be caused to circularly reach delivery areas a1 each having a diameter d1 on the packaging film 10.

Next, an operation of the above ion generator 30a according to the first embodiment will be explained with reference to the drawings.

As shown in FIG. 2, when a high voltage of about 5 kilovolts is supplied to the device main body 40 from the power-supply unit 50 via the power-supply cable 51 by operating a controller (not shown), the high voltage is applied to the fixed ends 44a of the discharge electrodes 44. As a result, a corona discharge (not shown) is generated from the free ends 44b of the discharge electrodes 44.

The corona discharge is generated in irregular directions (front/rear/left/right directions) from the free ends 44b of the discharge electrodes 44, and repulsive force is generated in a direction opposite to the generation direction of the corona discharge. The repulsive force caused by the corona discharge bends the free end 44b of the discharge electrode 44 in a direction opposite to the generation direction of the corona discharge. Since the generation direction of the corona discharge is irregularly varied, the free end 44b of the discharge electrode 44 performs a turning motion so as to form an approximately conical shape as shown by the two-dot chain line in the drawing. Therefore, the positive air ions EI are blown onto a wide area of the packaging film 10 from the free end 44b of the discharge electrode 44.

The air ions EI blown from the free end 44b of each of the discharge electrodes 44, each of which are performing the turning motion, forms the delivery area a1 having a diameter d1 as shown in FIG. 3. The delivery areas a1 of the discharge electrodes 44 adjacent to each other are mutually partially overlapped in the width direction of the packaging film 10 (horizontal direction in the drawing). Therefore, when the packaging film 10 is moved in the direction of the arrow “M”, the entire area (shaded area in the drawing) of the electrically-charged section “E” along the width direction of the packaging film 10 can be electrically neutralized.

Here, the rotating speed (work feeding speed) of the roller members 21 and 22 of the film supplying apparatus 20 is set so that, when focusing on one part of the packaging film 10, it takes about two seconds for that part to pass through the delivery areas a1. In other words, the work feeding speed is set so that the static electricity of the packaging film 10 can be sufficiently eliminated.

Next, an ion generator (comparison example) provided with fixed-type discharge electrodes, each of which is not vibrated, will be explained in detail with reference to the drawings. Parts the same in function as those of the ion generator 30a according to the above first embodiment are denoted by the same reference symbols, and detail explanation thereof will be omitted.

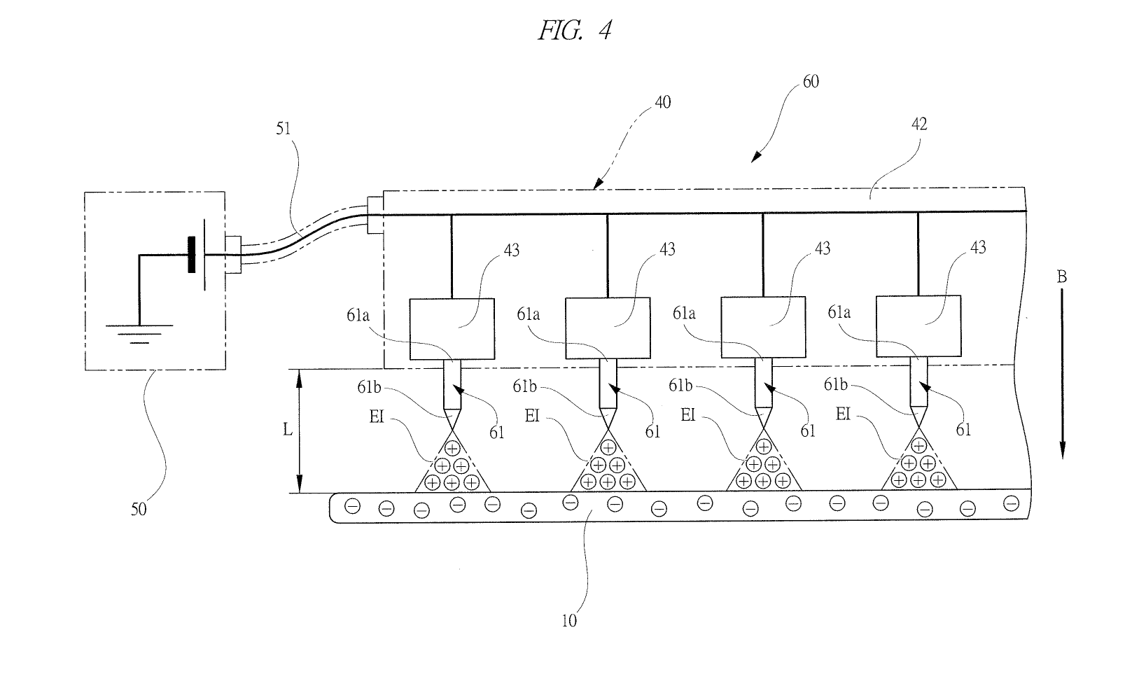

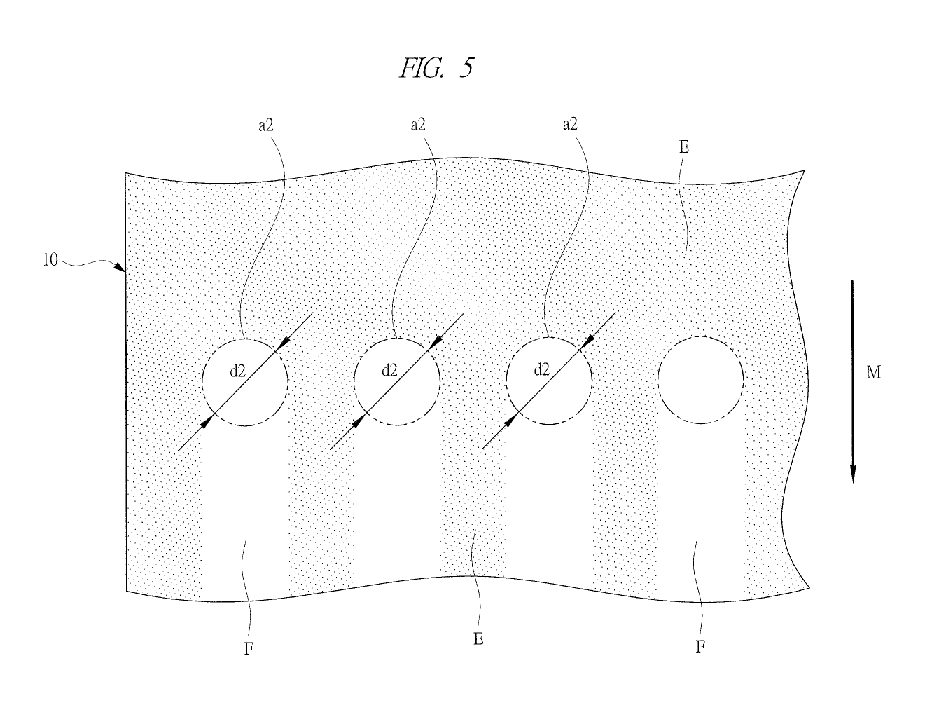

FIG. 4 is an explanatory diagram corresponding to that of FIG. 2, and showing a comparison example of the ion generator (fixed discharge electrode specification), and FIG. 5 is a B-arrow diagram explaining the size of a delivery area to which air ions are carried, in the ion generator (comparison example) shown in FIG. 4.

In the ion generator 60 as a comparison example, fixed-type discharge needles 61, each of which is not vibrated, are fixed to respective bases 43. Each diameter of the discharge needles 61 is set to, for example, 2 millimeters, since each needle has a sufficient diameter (or rigidity), they are not elastically deformed (swung or vibrated) by generation of corona discharge. Fixed ends (base ends) 61a of the discharge needles 61 are inserted in the respective bases 43, and their distal ends 61b are tapered so as to easily generate a corona discharge.

Air ions EI generated at the distal end 61b of each of the discharge needles 61, as shown in FIG. 5, form a delivery area a2 having a diameter d2 (d2<d1), and there is no partial overlap between the delivery areas a2 of the discharge needles 61 adjacent to each other in the width direction (horizontal direction in the drawing) of the packaging film 10. In other words, electrically-charged sections “E” aligned along the width direction are left in the packaging film 10 passed through the ion generator 60 (device main body 40).

Here, on the assumption that the distance between the device main body 40 and the packaging film 10 is set to a value “L”, the delivery area of the ion generator 30a according to the present invention shown in FIGS. 2 and 3 can be enlarged in comparison with that of the ion generator 60 (comparison example) shown in FIGS. 4 and 5 (a1>a2). In other words, in order to electrically neutralize the packaging film 10 without remaining electrically-charged section “E” by using the apparatus of the comparison example, it is necessary to increase the distance “L” between the device main body 40 and the packaging film 10, and this distance leads to an increase in the mounting space for the ion generator. On the other hand, since the delivery area can be increased in the ion generator of the present invention, even if it is difficult to secure a sufficient mounting space for the ion generator, the delivery area can be supported (space-saving supporting type).

In the ion generator 30a according to the above first embodiment, since the flexible discharge electrode 44 composed of one wire is provided to the base 43, and the free end 44b of the discharge electrode 44 is configured to perform a turning motion around the fixed end 44a by the repulsive force from the corona discharge which is generated when a high voltage is supplied to the fixed end 44a of the discharge electrode 44, in comparison with a bundle electrode composed of a plurality of thin wires, the amount of dust emission from the free end 44b of the discharge electrode 44 can be significantly reduced. Therefore, the ion generator 30a can be further improved in maintenance interval. Since the discharge electrode 44 is composed of a single wire, the downsized ion generator 30a can be realized, furthermore, the state of the discharge electrode 44 can be easily observed, and its maintenance can be simplified. Since the discharge electrode 44 performs the turning motion, the generated air ions EI can be transported to the wide area of the packaging film 10, and ionizing efficiency can be increased.

Furthermore, according to the ion generator 30a of the first embodiment, each of the discharge electrodes 44 is made of titanium alloy, and each diameter size is set to 70 micrometers. Therefore, for example, in comparison with tungsten alloy, the amount of dust emission can be reduced while each electrode can have high mechanical strength, and each electrode can be swung or vibrated while having sufficient flexibility. Therefore, the ion generator 30a can be further improved in maintenance interval, and the generated air ions “EI” can be transported to a wide area.

Next, the second embodiment of the present invention will be explained in detail with reference to the drawings. Additionally, parts the same in function as those of the first embodiment are denoted by the same reference symbols, and detailed explanation thereof will be omitted.

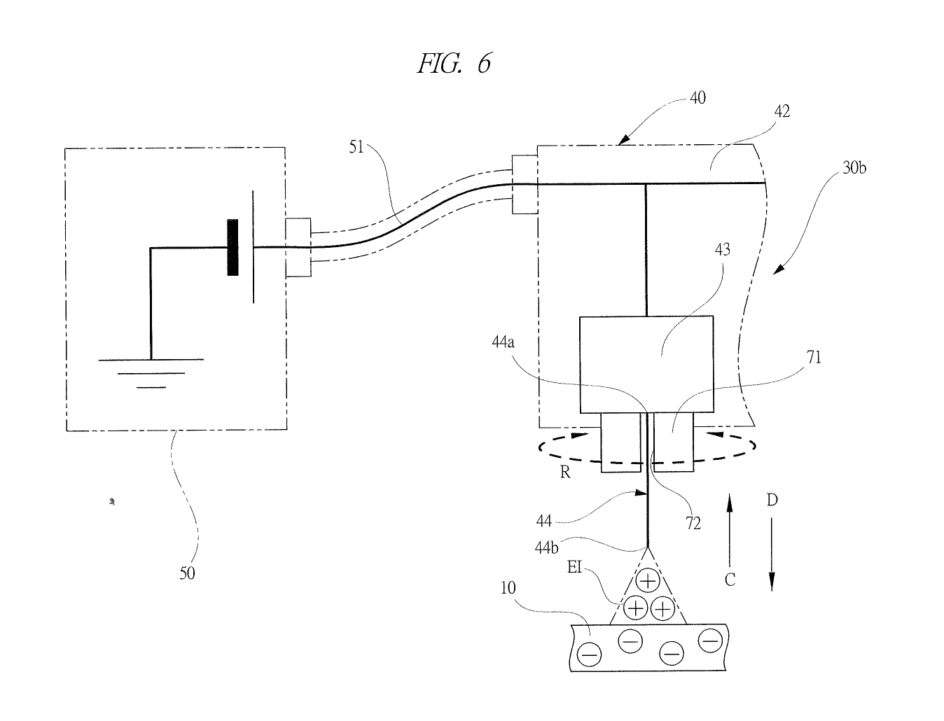

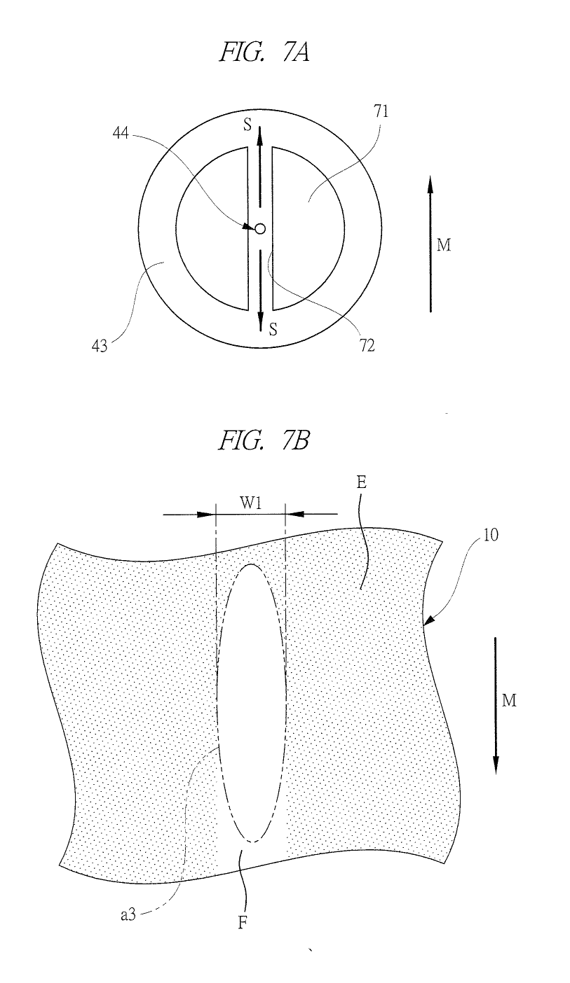

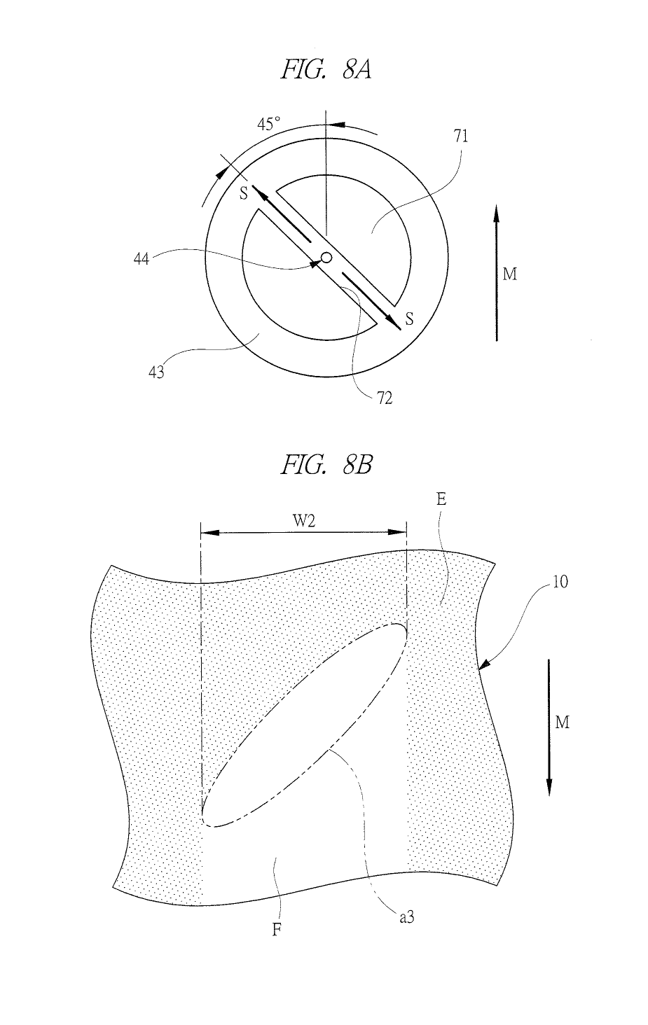

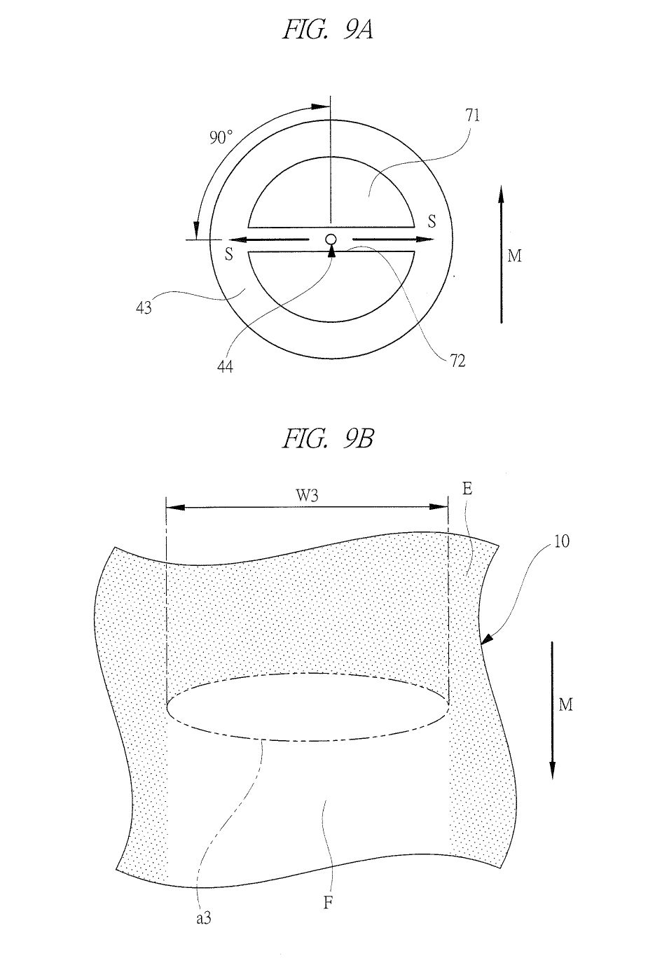

FIG. 6 is an explanatory diagram explaining the structure of the ion generator 30b according to the second embodiment, FIGS. 7A and 7B are explanatory diagrams explaining a first setup state (delivery width: small) of the ion generator 30b shown in FIG. 6, FIGS. 8A and 8B are explanatory diagrams explaining a second setup state (delivery width: middle) of the ion generator 30b shown in FIG. 6, and FIGS. 9A and 9B are explanatory diagrams explaining a third setup state (delivery width: large) of the ion generator 30b shown in FIG. 6.

As shown in FIG. 6, the ion generator 30b according to the second embodiment differs from the ion generator 30a according to the above first embodiment in that the discharge nozzle 41 (see FIG. 1) mounted on the casing 42 of the main body 40 is provided with a turning-motion control member 71 for controlling the turning motion state of the discharge electrode 41, and its delivery area of air ions EI on the packaging film 10 is adjustable in width.

The turning-motion control member 71 is formed of resin material (non-conductive material) such as for example plastic, and into an approximately cylindrical shape, and its base-end is mounted on the base 43 so as to be rotatable in the directions of broken-line arrows “R”. The turning-motion control member 71 is formed with a slit 72 which extends along its axial direction from its distal end side toward its base end side, and which faces a center part of the turning-motion control member 71. The width size of the slit 72 is set to a value larger in diameter than the discharge electrode 44, for example, set to 150 to 300 micrometers, so that the turning motion of the discharge electrode 44 can be performed in the slit 72 along the formation direction of the slit 72.

FIGS. 7A, 8A, and 9A are C-arrow views of FIG. 6, since the diameter of the discharge electrode 44 differs in size from the width of the slit 72, the discharge electrode 44 is moved so as to turn in the directions of arrows “S” in the slit 72. And since the turning-motion state of the discharge electrode 44, in other words, the direction of the turning motion of the discharge electrode 44 can be controlled with respect to the moving direction of the packaging film 10 (the direction of the arrow “M”) by causing the turning-motion control member 71 to rotate with respect to the base 43.

FIGS. 7B, 8B, and 9B are D-arrow views of FIG. 6, as shown in FIG. 7A, when the relative angle (adjustment angle) of the turning-motion control member 71 with respect to the base 43 is set to 0 degree to go into the first adjustment state, the discharge electrode 44 is regulated by the turning-motion control member 71 so as to perform a turning motion along the direction of the moving direction “M” of the packaging film 10. As a result, as shown in FIG. 7B, a delivery area a3 of air ions EI, which has a width W1 and an approximately elliptical shape, can be obtained (delivery width: small).

Furthermore, as shown in FIG. 8A, when the relative angle (adjustment angle) of the discharge electrode 44 regulated by the turning-motion control member 71 with respect to the base 43 is set to 45 degrees to go into the second adjustment state, the discharge electrode 44 is regulated by the turning-motion control member 71 so as to perform a turning motion in a state that the discharge electrode is shifted by 45 degrees with respect to the moving direction “M” of the packaging film 10. As a result, as shown in FIG. 8 (b), the delivery area a3 of the air ions EI which has a width W2 (W2>W1) and an approximately elliptical shape can be obtained (delivery width: medium).

Furthermore, as shown in FIG. 9A, when the relative angle (adjustment angle) of the turning-motion control member 71 with respect to the base 43 is set to 90 degrees to go into the third adjustment state, the discharge electrode 44 is regulated by the turning-motion control member 71 so as to perform a turning motion in a state where the discharge electrode is shifted by 90 degrees with respect to the moving direction “M” of the packaging film 10. As a result, as shown in FIG. 9B, the delivery area a3 of the air ions EI which has a width W3 (W3>W2) and an approximately elliptical shape can be obtained (delivery width: large).

Also in the thus-formed second embodiment, it is possible to attain the same effects as those of the above first embodiment. In addition to this, since a turning-motion control member 71 for controlling the turning-motion state of the discharge electrode 44 is provided in the second embodiment, the size, in other words, the delivery width of the delivery area a3 of the generated air ions EI can be arbitrarily controlled in accordance with, for example, the shape of the packaging film 10 or another object to be electrically neutralized.

Next, the third embodiment of the present invention will be explained in detail with reference to the drawings. Additionally, parts the same in function as those of the above first embodiment are denoted by the same reference symbols, and detail explanation thereof will be omitted.

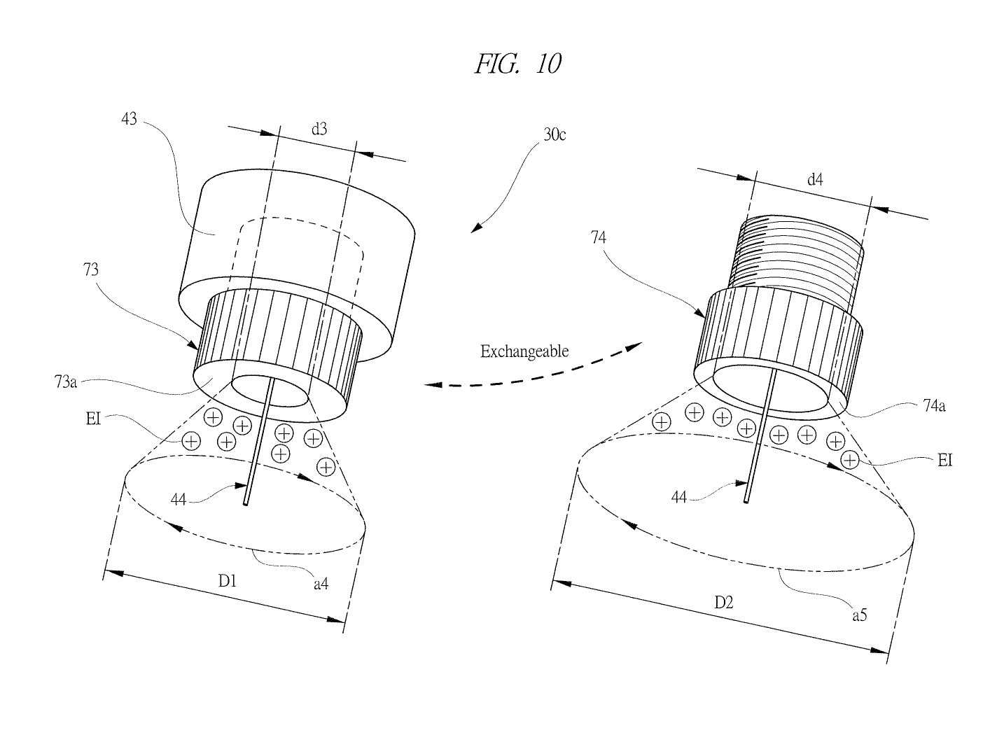

FIG. 10 is an explanatory diagram explaining a main section of the ion generator 30c according to the third embodiment.

As shown in FIG. 10, the ion generator 30c according to the third embodiment differs from the ion generator 30a according to the above first embodiment in that a first replaceable discharge-electrode unit 73 is provided to the discharge nozzle 41 (see FIG. 1) mounted on the casing 42 of the main body 40, and the first replaceable discharge-electrode unit 73 can be attached to the base 43 in the detachable manner, and can be replaced with a second replaceable discharge-electrode unit 74 based on another specification.

The first replaceable discharge-electrode unit 73 is formed of resin material (non-conductive material) such as for example plastic, and into a cylindrical shape, and the first replaceable discharge-electrode unit 73 is provided with a turning-motion control cylindrical part 73a of which inner-diameter size is set to d3. The turning-motion control cylindrical part 73a is configured to regulate the diameter size of the delivery area a4 of the air ions EI, which are transported by the discharge electrode 44, to D1.

The second replaceable discharge-electrode unit 74 is formed of resin material (non-conductive material) such as for example plastic, and into a cylindrical shape, and the second replaceable discharge-electrode unit 74 is provided with a turning-motion control cylindrical part 74a, and its inner-diameter is set to a value d4 (d4>d3). The turning-motion control cylindrical part 74a is configured to regulate the diameter size of the delivery area a5 of the air ions EI, which are transported by the discharge electrode 44, to D2 (D2>D1).

In this case, each of the turning-motion control cylindrical parts 73a and 74a constitutes a turning-motion control member in the present invention.

Also in the above third embodiment, the same effects as those of the above first embodiment can be exerted. In addition to this, since the discharge nozzle 41 is provided with the first replaceable discharge-electrode unit 73, which is exchangeable, in the third embodiment, in accordance with the shape or the like of the packaging film 10 or another object to be electrically neutralized, it is possible to replace the attached first replaceable discharge-electrode unit 73 with the second replaceable discharge-electrode unit 74 having another different specifications.

Next, the fourth to sixth embodiments of the present invention will be explained in detail with reference to the drawings. Additionally, parts the same in function as those of the above first embodiment are denoted by the same reference symbols, and detail explanation thereof will be omitted.

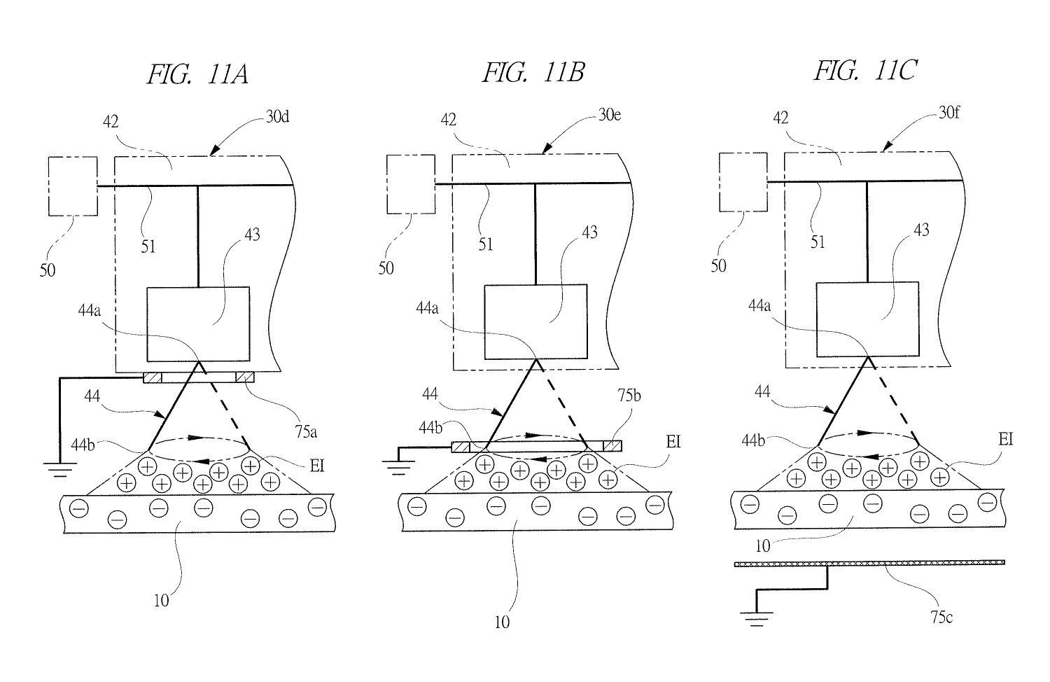

FIGS. 11A, 11B, and 11C are explanatory diagrams respectively explaining the structures of the ion generators according to fourth to sixth embodiments.

As shown in FIGS. 11A, 11B, and 11C, each of the ion generators 30d to 30f according to the fourth to sixth embodiments differs from the ion generator 30a according to the above first embodiment in that electrically-grounded opposite electrodes 75a to 75c made of metal are located around the respective discharge electrodes 44 or respective opposite portions of the free ends 44b of the discharge electrodes 44.

As shown in FIG. 11A, the ion generator 30d according to the fourth embodiment is provided with an annular opposite electrode 75a which is arranged on the same side as the fixed end 44a of the discharge electrode 44 so as to encircle it. By virtue of this configuration, the generation direction of the corona discharge from the discharge electrode 44 can be directed to the opposite electrode 75a, and as a result, it is possible to increase the angle range of the turning motion of the discharge electrode 44. Therefore, it is possible to attain the same effects as those of the first embodiment, and to further increase the delivery area of the air ions EI with respect to the packaging film 10.

As shown in FIG. 11B, the ion generator 30e according to the fifth embodiment is provided with an annular opposite electrode 75b which is arranged on the same side as the free end 44b of the discharge electrode 44 so as to encircle it. By virtue of this configuration, the generation direction of the corona discharge from the discharge electrode 44 can be directed to the opposite electrode 75b, and as a result, it is possible to cause the free end 44b of the discharge electrode 44 to stably perform the turning motion along the inner periphery of the opposite electrode 75b. Therefore, it is possible to attain the same effects as those of the first embodiment, and to further increase the delivery area of the air ions EI with respect to the packaging film 10.

As shown in FIG. 11C, the ion generator 30f according to the sixth embodiment is provided with a mesh-like (net-like) or a plate-like opposite electrode 75c located on the far side of the packaging film 10. As a result, the generation direction of the corona discharge from the discharge electrode 44 can be reliably directed to the packaging film 10.

As explained above, the ion generators 30d to 30f according to the fourth to sixth embodiments can attain the same effects as those of the first embodiment, and since they are provided with opposite electrodes 75a to 75c, it is possible to guide the generation direction of the corona discharge, and to generate the corona discharge from the discharge electrode 44 even at a low voltage. Therefore, it is possible to further reduce the amount of dust emission from the discharge electrode 44, and to save electric power which is used in the ion generator. Furthermore, since the generation direction of the corona discharge is guided and directed to the packaging film 10 so that the air ions EI can be efficiently transported, the electrical-neutralization time of the packaging film 10 can be further shortened (electrical-neutralization efficiency can be further improved). Therefore, the feeding speed of the packaging film 10 can be increased, and the film supplying apparatus 20 can be enhanced in efficiency.

In the above described embodiments, the discharge electrode 44 has a circular shape in cross section, but it is possible to cause the free end to perform the swinging motion or the turning motion even if the discharge electrode has a quadrangular shape in cross section. In the above embodiments, the short distance between the discharge electrode 44 and the packaging film 10 causes the air ions EI to reach the packaging film 10. However, the present invention is not limited to this, and an air supply source may be connected to the ion generator, and the air ions EI may be blown from the discharge nozzles 41 toward the packaging film 10 together with supplied air.

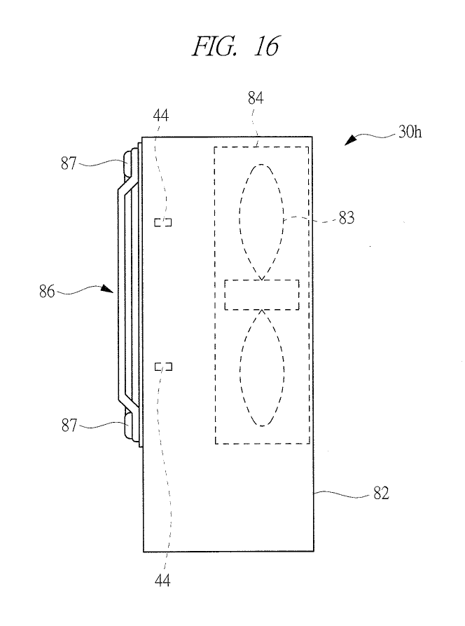

Next, a case in which the present invention is applied to a fan type ion generator will be explained in detail with reference to FIGS. 12 to 22.

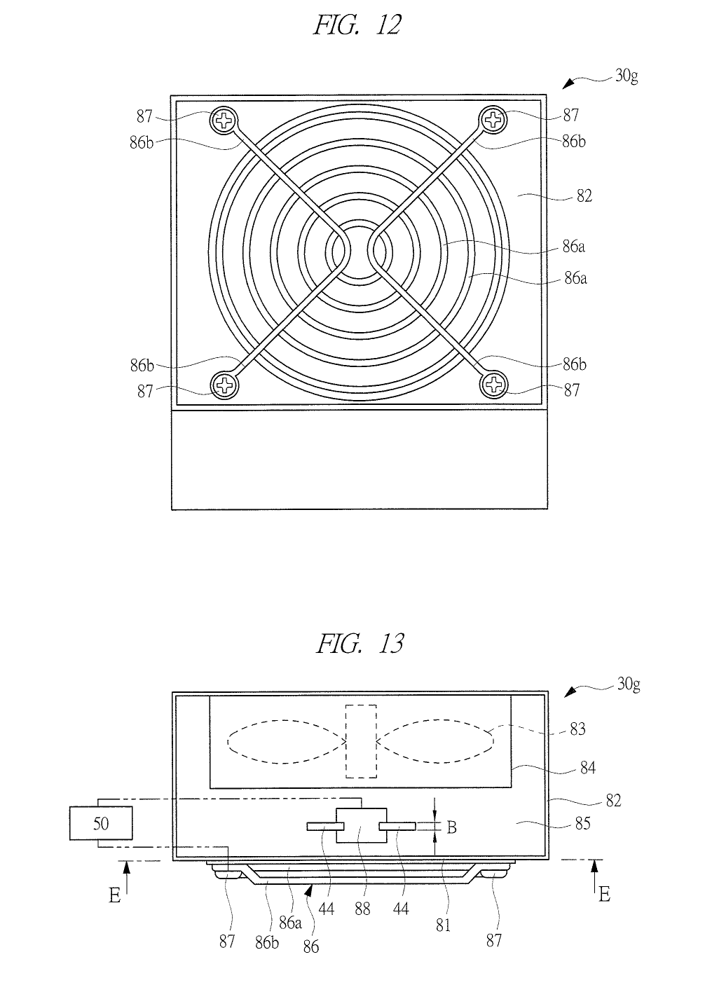

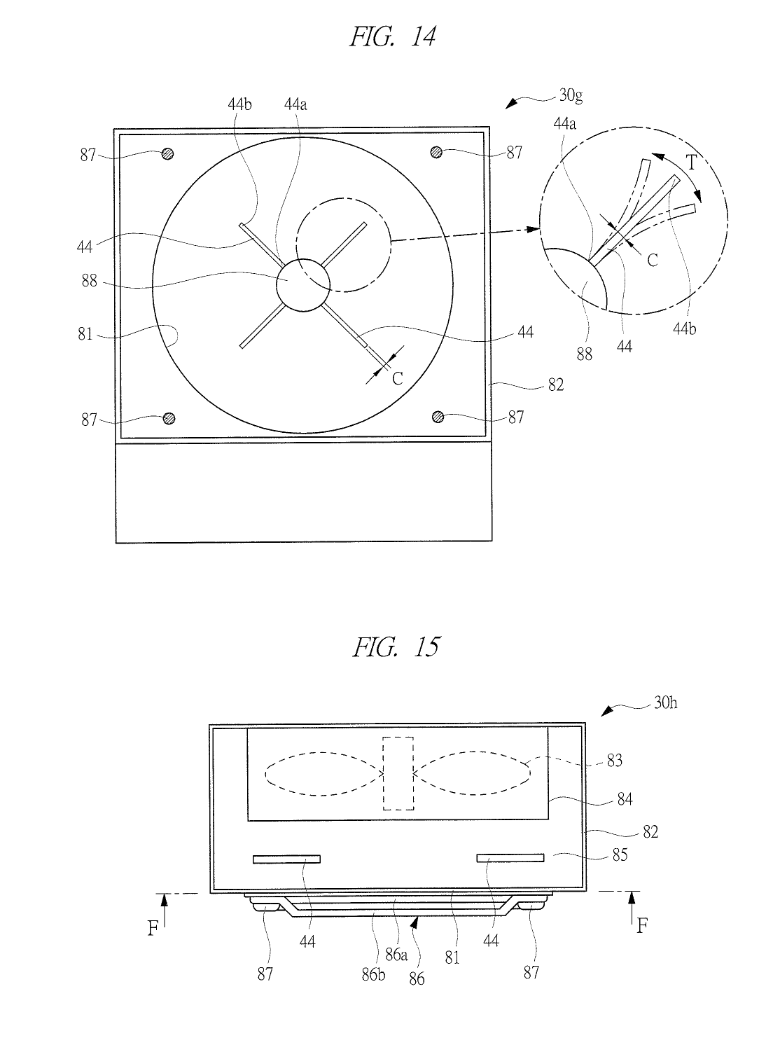

An ion generator 30g according to the seventh embodiment shown in FIGS. 12 to 14 has a housing 82 for air supply formed with an air outlet 81 as shown in FIG. 14. A fan case 84 in which an axial flow fan 83 is built is disposed in the housing 82 as shown in FIG. 13, and the fan 83 is driven by an electric motor (not shown) disposed on the back side of the housing 82. When the fan 83 is driven and rotated, air flows from the outside into an air inlet formed on the back side of the housing 82, the flowed air is discharged from the air outlet 81, and the housing 82 is formed with an air supply channel 85 for guiding the flowed air to the air outlet 81.

A conductive member 86 having a hole through which air is passed is attached to the housing 82 so as to cover the air outlet 81, and the conductive member 86 constitutes an opposite electrode. The conductive member 86 has: a plurality of concentric annular parts 86a; and a plurality of supporting leg parts 86b fixed to them, and base ends of the supporting leg parts 86b are fixed to the housing 82 by screw members 87. Air to be discharged from the air outlet 81 is discharged to the outside via gaps of the conductive member 86.

As shown in FIGS. 13 and 14, an electrode holder 88 is disposed in the housing 82 so as to face the center part of the air outlet 81, and fixed to the housing 82 by a support member (not shown). Four discharge electrodes 44 made of flexible material are attached in a radial shape to this electrode holder 88 so as to protrude in a radially outward direction, and a base end, in other words, the fixed end 44a of each discharge electrode 44 is fixed to the electrode holder 88. The discharge electrodes 44 are arranged, in parallel with the conductive member 86 serving as an opposite electrode, behind the conductive member 86, and extend in a crossing direction with respect to air guided into the housing 82.

The conductive member 86 and the discharge electrodes 44 are connected to the power-supply unit 50 shown in FIG. 13, and a high voltage is supplied from the power-supply unit 50 to the conductive member 86 and the discharge electrodes 44. When electric power is applied from the power-supply unit 50 to the conductive member 86 serving as the opposite electrode and the discharge electrodes 44 with air being supplied from the air supply channel 85 to the air outlet 81, corona discharge is generated between the tip ends of the discharge electrodes 44 and the conductive member 86, air flowing around the discharge electrodes 44 is ionized by the corona discharge, and air ions are generated.

In each discharge electrode 44, as shown in FIG. 14, the base end is fixed to the electrode holder 88, and the tip end serves as a free end 44b. The width “B” of each discharge electrode 44 in an air flow direction is larger than the thickness “C” thereof, and each discharge electrode 44 has a rectangular shape in cross section. When electric power is supplied to the discharge electrodes 44 with air flowing from the air outlet 81, the free end of each discharge electrode 44 receives repulsive force from the corona discharge. When the free end receives the repulsive force with air flowing, as shown by a reference character “T” in FIG. 14, the free end performs the swinging motion along the conductive member 86, in other words, in a crossing direction with respect to air flowing toward the air outlet 81. The width “B” of the discharge electrode 44 is about 1 millimeter, and the thickness size thereof is about 50 micrometers.

Therefore, when the tip ends of the discharge electrodes 44 made of flexible material are swung or vibrated in a crossing direction with respect to air flow as shown in FIG. 14, air ions generated by the corona discharge are diffused in a wide area along a circumferential direction of the electrode holder 88. As shown in FIG. 14, since the electrode holder 88 is provided with four discharge electrodes 44 which are arranged in specific intervals in the circumferential direction thereof, air ions are generated in the wide area over the entire circumference of the electrode holder 88 in the radially outward direction of the electrode holder 88. The number of the discharge electrodes 44 disposed in the housing 82 is not limited to four, and in the case where a plurality of discharge electrodes 44, for example, four or so discharge electrodes 44 are disposed as shown in the drawing, air ions can be blown from the entire air outlet 81. As a result, the distribution density of air ions can be totally equalized, and the surface of an object can be totally uniformly electrically neutralized.

Since the free ends of the discharge electrodes 44 performs a swinging motion or a vibrating motion in the above described manner, even if dust is contained in air to be supplied from the outside, the dust can be prevented from adhering to the discharge electrodes 44. Since the swinging direction of each free end is defined in the crossing direction with respect to air flow, the distance between the object disposed in front of the air outlet 81 and each discharge electrode 44 is not changed at the time of generation of air ions. Therefore, air ions having a totally equalized ionization density can be blown onto the object.

In the above described discharge electrode 44, the width “B” in the air flow direction is larger than the thickness “C”, and the discharge electrode 44 is constructed so as to be easily swung and deformed in the circumferential direction of the electrode holder 88, in other words, in the crossing direction with respect to air flow, therefore, when the repulsive force is applied to the discharge electrodes 44 at the time of corona discharge, the free end of the discharge electrode 44 performs the swinging motion in the crossing direction with respect to air flow. However, even if the discharge electrode 44 is circular or square in cross section, the free end can be swung in the above described direction by the repulsive force and a pulsing motion of air flow at the time of corona discharge.

The conductive member 86 covering the air outlet 81 is attached to the housing 82 so as to cover the air outlet 81 and can prevent an operator from carelessly inserting, for example, his/her finger into the housing 82. And, since the conductive member 86 is disposed in the crossing direction with respect to air flow, when the free end is swung in the crossing direction with respect to air flow, it is possible to constantly generate stable corona discharge without changing the distance between the discharge electrode 44 and the conductive member 86. Furthermore, since the swinging direction of the discharge electrode 44 is the same as the crossing direction with respect to air flow, the distance between the fan case 84 and the conductive member 86 can be reduced, and the ion generator can be downsized.

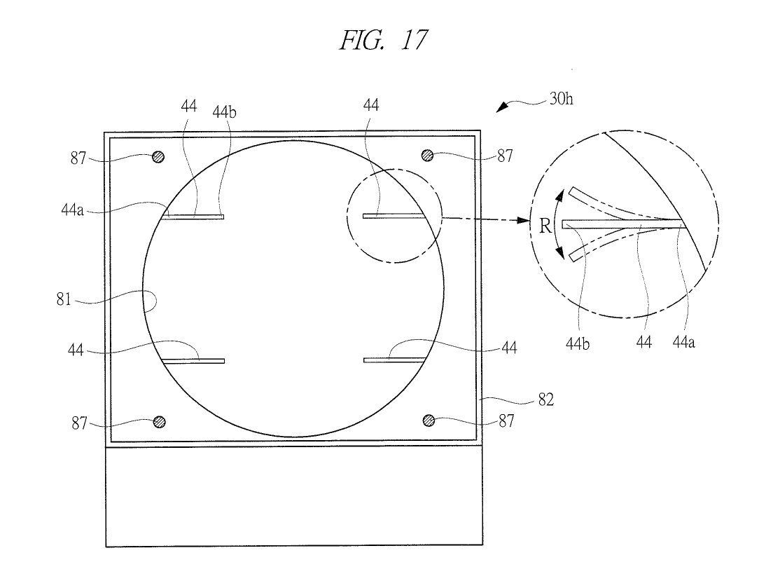

In an ion generator 30h shown in FIGS. 15 to 17, as well as the above described case, four discharge electrodes 44 made of flexible material extend from the outer peripheral part of the air outlet 81 in an inward direction, and are disposed in the crossing direction with respect to air flow. Even if the discharge electrodes 44 are disposed as shown in FIG. 17, the free ends of the discharge electrodes 44 can be swung or vibrated as well as the case in which the discharge electrodes 44 are disposed at the center part of the air outlet 81 as described above.

Although, in FIG. 17, two of the discharge electrodes 44 are disposed in parallel to each other on the right side of the air outlet 81, and the remaining two discharge electrodes 44 are disposed in parallel to each other on the left side of the air outlet 81, the discharge electrodes 44 may be radially disposed so as to extend toward the center part of the circular air outlet 81. Additionally, note that the power-supply unit 50 is omitted from FIGS. 15 to 17.

The discharge electrodes 44 disposed at the center part of the air outlet 81 as shown in FIGS. 12 to 14, and the discharge electrodes 44 disposed at the peripheral part of the air outlet 81 as shown in FIGS. 15 to 17 constitute a combined ion generator.

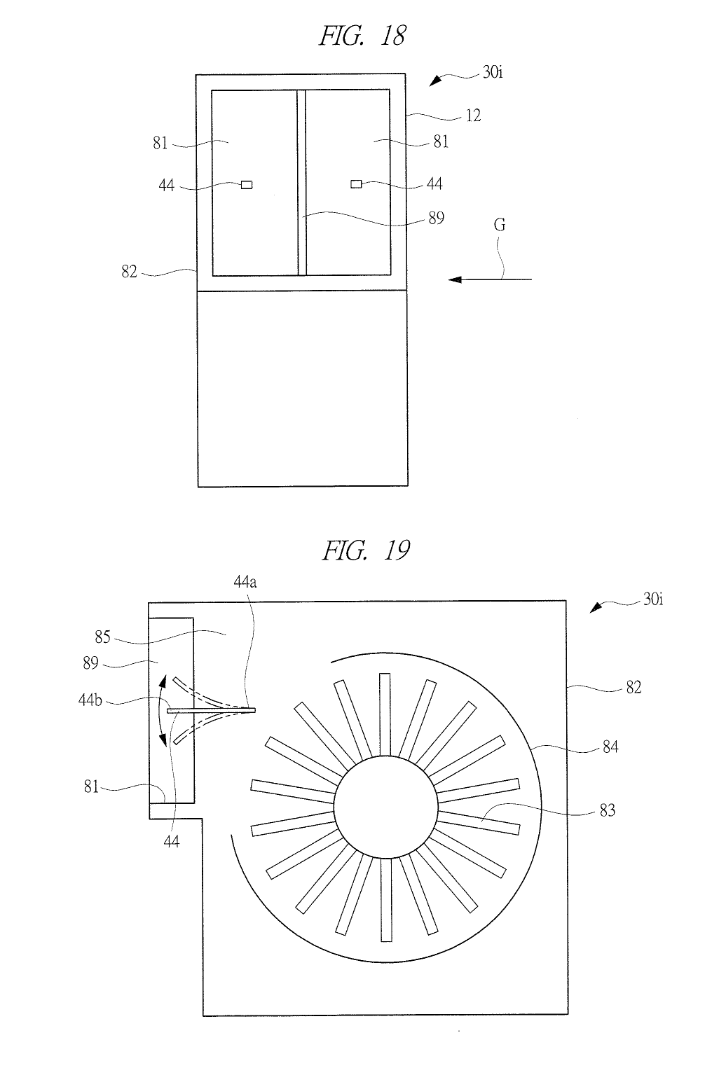

In the housing 82 of an ion generator 30i shown in FIGS. 18 and 19, two air outlets 81 separated by a partition wall 89 are formed. Two discharge electrodes 44 are disposed in the housing 82 so as to correspond to the respective air outlets 81. As shown in FIG. 19, in this ion generator 30i, the discharge electrodes 44 are disposed so as to extend along air flow in the housing 82, in other words, in a direction toward the air outlets 81, and at the time of corona discharge, the free ends of the discharge electrodes 44 are swung in the vertical direction in FIG. 18, in other words, in the crossing direction with respect to air flow. As shown in FIG. 19, the fan 83 is a multiple blade type, and external air is introduced into the housing 82 from the lateral side thereof as shown by an arrow “G” in FIG. 18. Additionally, as another layout mode of opposite electrodes, conductive members may be attached so as to cover the air outlets 81 as described above, or opposite electrodes may be disposed at upper and lower ends of the air outlets 81.

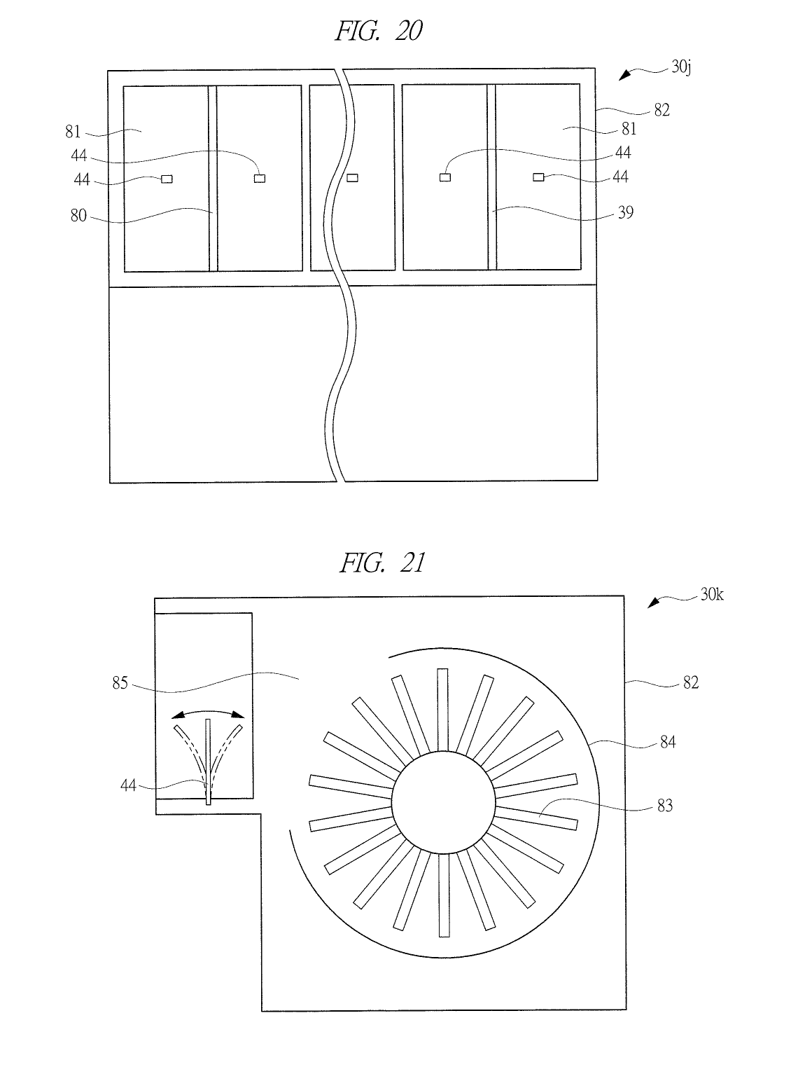

FIG. 20 shows an ion generator 30j in which the housing 82 is provided with many air outlets 81, as well as the case shown in FIG. 19, the discharge electrodes 44 are disposed so as to extend along air flow, corresponds to the respective air outlets 81 in the housing 82, and the free ends of the discharge electrodes 44 are swung in the crossing direction with respect to air flow. Other structure thereof is the same as those of FIGS. 18 and 19.

FIG. 21 is a cross sectional view showing an ion generator 30k according to the eleventh embodiment, and in this case, the free end of the discharge electrode 44 is swung along air flow. While the free end is swung in this direction, air ionized by the corona discharge can be diffused in a wide area. By taking a swinging stroke into consideration, as will be seen from comparison with FIG. 19, the size of the housing 82 in the left-right direction in FIG. 21 is increased, and the size of the ion generator 30k is increased. On the other hand, if the free end of the discharge electrode 44 is swung in the crossing direction with respect to air flow, the air outlet 81 and the fan case 84 can be reduced in size, and the ion generator can be downsized.

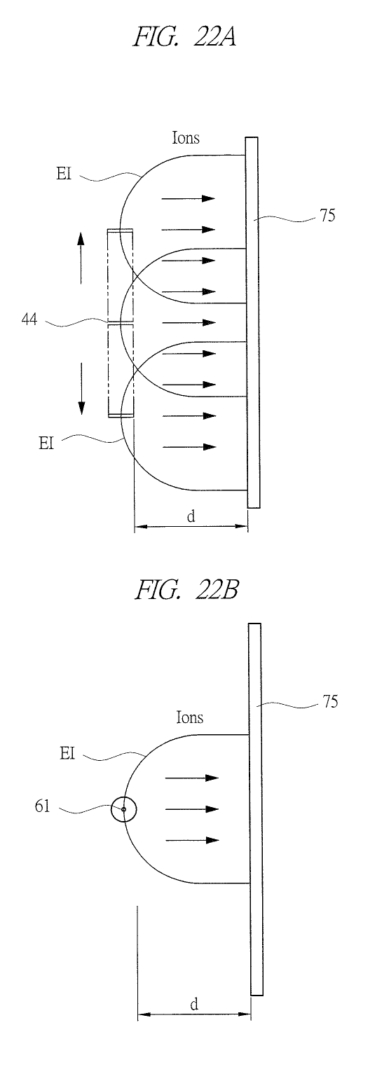

FIG. 22A is a schematic view showing an air ions generating state by the swinging type discharge electrode 44, and FIG. 22B is a schematic view showing an air ions generating state by the fixed type discharge electrode, in other words, a discharge needle 61 shown as a comparison example. The distance “d” between the opposite electrode 75 and the discharge electrode 44 is the same as the distance “d” between the opposite electrode 75 and the discharge needle 61 of the comparison example.

In FIGS. 22A and 22B, arrows show a range in which air ions are generated, and a reference character “EI” shows a distribution state of air ions generated by corona discharge between the opposite electrodes and the discharge electrodes. As shown in FIG. 22A, since the free end of the discharge electrode 44 is swung so as to cross air flow, the air ions EI can be generated in a wide area. On the other hand, when the fixed-type discharge electrode, in other words, the discharge needle 61 is used as shown in FIG. 22B, generation of air ions is limited to a small area.

When the free end of the discharge electrode 44 made of flexible material is swung or vibrated in this manner by the repulsive force of the corona discharge, dust contained in the external air is prevented from adhering to the discharge electrode 44, air ions EI generated by the corona discharge are diffused in a wide area, and the distribution density of air ions to be discharged from the air outlet 81 is totally equalized. Therefore, the surface of an object can be totally uniformly electrically neutralized. Furthermore, although the free end is swung in the crossing direction with respect to air flow, since the distance between the object disposed in front of the air outlet 81 and the discharge electrode 44 is not changed at the time of generation of air ions, air ions having an equalized ionization density can be blown onto the object.

In the ion generators 30g to 30k shown in FIGS. 12 to 20, the fan 83 is built in the housing 82. However, without providing an air blower, in other words, a fan in the housing 82, air may be supplied from the outside of the housing 82. In this case, only the discharge electrode 44 is provided in the air supply channel 85 for guiding air supplied from the outside to the air outlet 81.

The present invention is not limited to the above described embodiments, and it will be obvious to those skilled in the art that various changes may be made without departing from the scope of the invention. For example, although the discharge electrodes 44 are made of titanium alloy in the above described embodiments, the present invention is not limited to this, and discharge electrodes made of other conductive materials such as tungsten and stainless steel may be employed on the basis of the electrical neutralization ability (specification) and the like of the ion generator.

Furthermore, in the above embodiments, the positive air ions “EI” are generated by the discharge electrodes 44. However, the present invention is not limited to the above embodiments. Based on the electrically-charged state (positive/negative) of the object to be electrically neutralized, negative air ions EI can be generated by the discharge electrodes 44, or positive or negative air ions EI can be alternately generated by the discharge electrodes 44.

### INDUSTRIAL APPLICABILITY

The ion generator is used for electrically neutralizing and eliminating static electricity from an electrostatically-charged plastic material.

What is claimed is:

1. An ion generator comprising a flexible discharge electrode which is composed of one wire, and which has a fixed end and a free end,
wherein a turning motion or a swinging motion of the free end about the fixed end is performed by repulsive force of a corona discharge generated by supplying a high voltage to the fixed end.

2. The ion generator according to claim 1, further comprising a turning-motion control member for controlling a turning motion of the discharge electrode.

3. The ion generator according to claim 1, wherein the discharge electrode is disposed in an air supply channel for guiding air toward an air outlet, and the free end performs the swinging motion.

4. The ion generator according to claim 3, wherein the free end of the discharge electrode performs the swinging motion in a crossing direction with respect to air flow toward the air outlet.

5. The ion generator according to claim 3, wherein the discharge electrode is disposed along the air outlet.

6. The ion generator according to claim 3, wherein the discharge electrode is disposed so as to extend toward the air outlet.

7. The ion generator according to claim 1, wherein the discharge electrode is set to 100 micrometers or less in cross section dimension.

8. The ion generator according to claim 1, wherein the discharge electrode is made of titanium alloy.
